(19) United States
(12) Patent Application Publication
(10) Pub. No.: US 2008/0184567 A1
(43) Pub. Date: Aug. 7, 2008

(54) Control Mechanism for Controlling Width of Two Cutting Blades

(75) Inventor: Titan Jou, Taichung (TW)

Correspondence Address: Dr. BANGER SHIA, 102 Lindencrest Ct., Sugar Land, TX, 77479-5201, US

(73) Assignee: NUSHARP INC.

(21) Appl. No.: 12/099,117

(22) Filed: Apr. 7, 2008

Related U.S. Application Data
(63) Continuation-in-part of application No. 11/066,473, filed on Feb. 28, 2005.

(51) Int. Cl. B26B 13/00

(52) U.S. Cl. 30/262

(57) ABSTRACT

A pair of scissors includes a first part which is pivotably connected to a second part. A stop extends from an inside of the second part. A control member rotatably extends through a connection hole in the first part and includes a plurality of engaging surfaces which have different radial heights so that the stop is engaged with one of the engaging surfaces to set the desired width between two blades of the first and second parts.

This application is a continuation of part of U.S. patent application Ser. No. 11/066,473, which claims the benefit of the earlier filing date of Feb. 28, 2005. claim 1 of this application is the combination of the previous claims 1, 4 and 5 of the U.S. patent application Ser. No. 11/066,473, claims 2 and 9 of this application are the previous claims 3 and 7 of the U.S. patent application Ser. No. 11/066,473, and claims 3-8 of the application are new.

### FIELD OF THE INVENTION

The present invention relates to a pair of pruning scissors, and more particularly to a control mechanism for controlling width between two cutting blades of pruning scissors, wherein the mechanism is located between the two handles and includes multiple controlling stages.

### BACKGROUND OF THE INVENTION

A conventional pair of pruning scissors with a lock device is disclosed in U.S. Pat. No. 6,418,626, the two pivotally connected cutting blades of the scissors are defined with a locking hole and a step hole, respectively, a latch post biased against by a spring is received in the step hole, and on one of the cutting blades with the step hole is mounted a knob which is defined with a cavity at the bottom thereof. After further analysis, we found that this conventional pair of pruning scissors has the following disadvantages:

The locking device only provides the user the options of fully opening or fully closing the scissors, and is unable to adjust the open width of the scissors to better fit different user's palm, thus further affecting the quality and easiness of the pruning operation.

The present invention intends to provide a control mechanism for controlling width between two cutting blades of pruning scissors, wherein the control mechanism is located between two handles so that it is not easily touched by the object to be cut and includes multiple control stages to set different widths between the two blades.

### SUMMARY OF THE INVENTION

The primary object of the present invention is to provide a control mechanism for controlling width between two cutting blades of a pair of pruning scissors, wherein a control member is disposed at one side of the pin of the scissors and used to engage with a stop, the rotation of the control member makes different portions of the control member engage with the stop engage, producing thickness difference, so that the open width of the scissors can be quickly adjusted and controlled.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a perspective view of the scissors with the two blades open wide;

FIG. 2 is an exploded view to show the scissors of the present invention;

FIG. 3 shows a perspective view of the scissors wherein the two blades are close with each other;

FIG. 4 shows the stop on the second part is engaged with the first engaging surface of the control member;

FIG. 5 shows the stop on the second part is engaged with the second engaging surface of the control member;

FIG. 6 shows that the tubular portion of the control member is a cam, and

FIG. 7 shows that the tubular portion of the control member includes three engaging surfaces.

### DETAILED DESCRIPTION OF THE PREFERRED EMBODIMENT

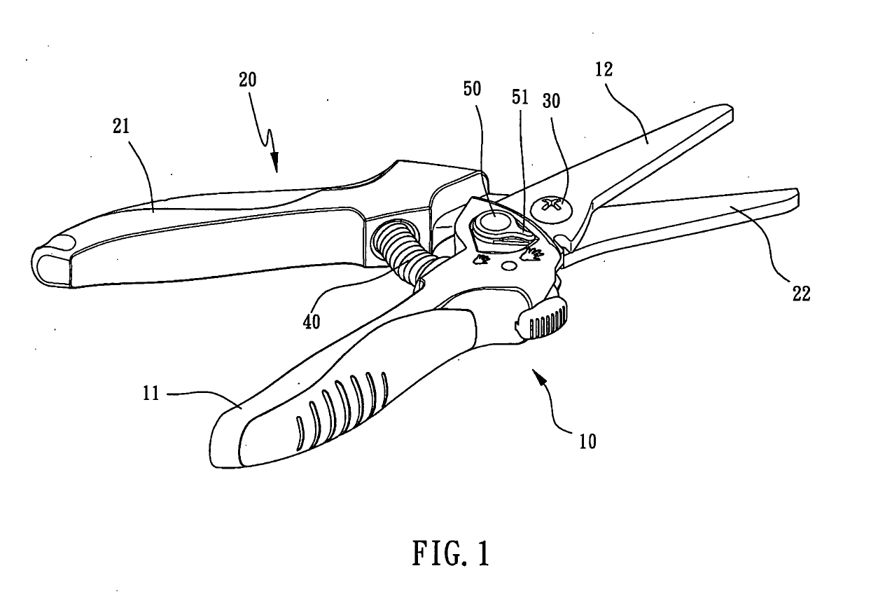

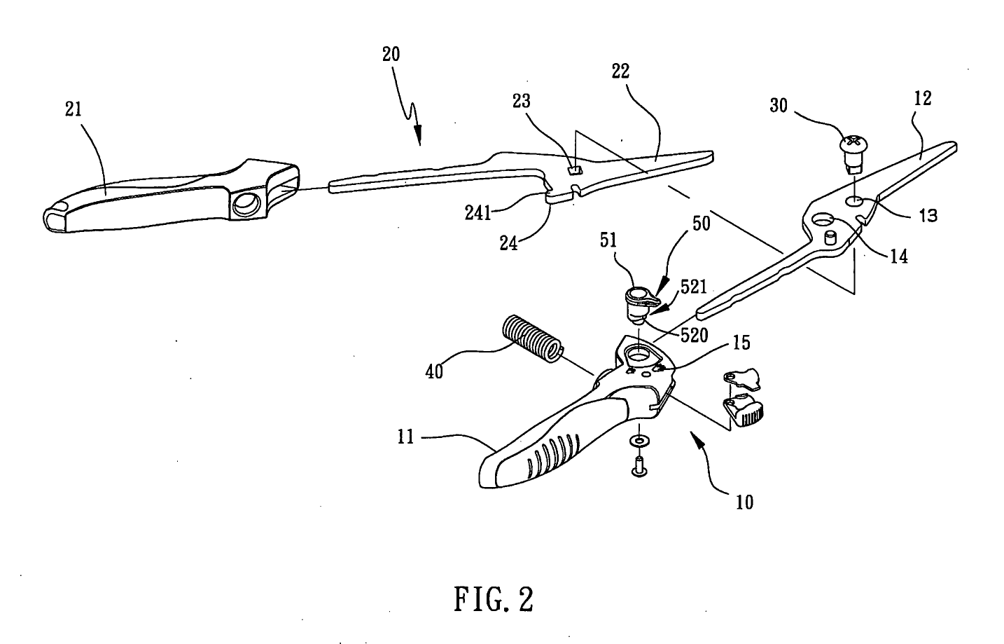

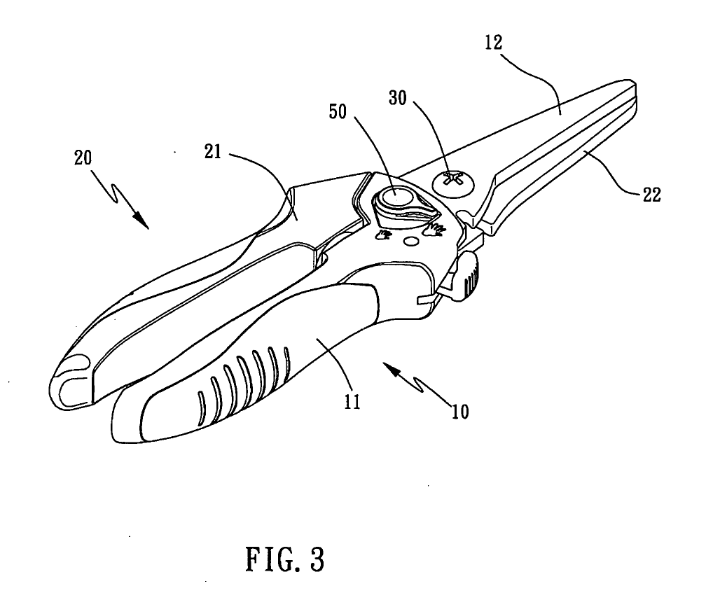

Referring to FIGS. 1 to 3, a pair of scissors of in accordance with the present invention comprises a first part 10, a second part 20, a pin 30, a spring 40, and a control member 50. The first part 10 has a first handle 11 which can be a grip mounted to the first handle 11, and a first blade 12 which is connected to an end of the first handle 11. A first pivotable hole 13 is defined in the first part 10 and located between the first handle 11 and the first blade 12. The first part 10 has a connection hole 14 which is located closer to the first handle 11 than the first pivotable hole 13.

The second part 20 has a second handle 21 which can be a grip mounted to the second handle 21, and a second blade 22 which is connected to an end of the second handle 21. A second pivotable hole 23 is defined in the second part 20 and located between the second handle 21 and the second blade 22. The pin 30 extends through the first and second pivotable holes 13, 23 so as to pivotably connect the first part 10 to the second part 20. The second part 20 has a stop 24 extending from an inside thereof and the stop 24 is located between the second pivotable hole 23 and the handle 21. The stop 24 extends toward the control member 50 to form a protrusion 241 and is mounted over the control member 50 so that the control member 50 is located between the second part 20 and the stop 24.

The control member 50 includes a tubular portion 52 and a lever 51 which extends from a top end thereof, the tubular portion 52 rotatably extends through the connection hole 14 and is fixed to the first part 10 by a screw member. The top end of the control member 50 is located at a top surface of the first part 10. A plurality of indexes 15 are marked on the top surface of the first part 10 and located beside the lever 51 so that the user may switch the lever 51 to point one of the indexes 15 which shows the width to be opened between the first and second blades 12, 22. The tubular portion 52 includes a plurality of engaging surfaces defined in an outer periphery of the tubular portion 52, in this embodiment, there are two engaging surfaces 520, 521 which have different radial heights, that is to say, a vertical thickness from an axis of the control member 50 to the engaging surface 520 is less than that from the axis of the control member 50 to the engaging surface 521. The spring 40 is connected between the first and second handles 11, 21 so that the first and second handles 11, 21 have a tendency to open wide.

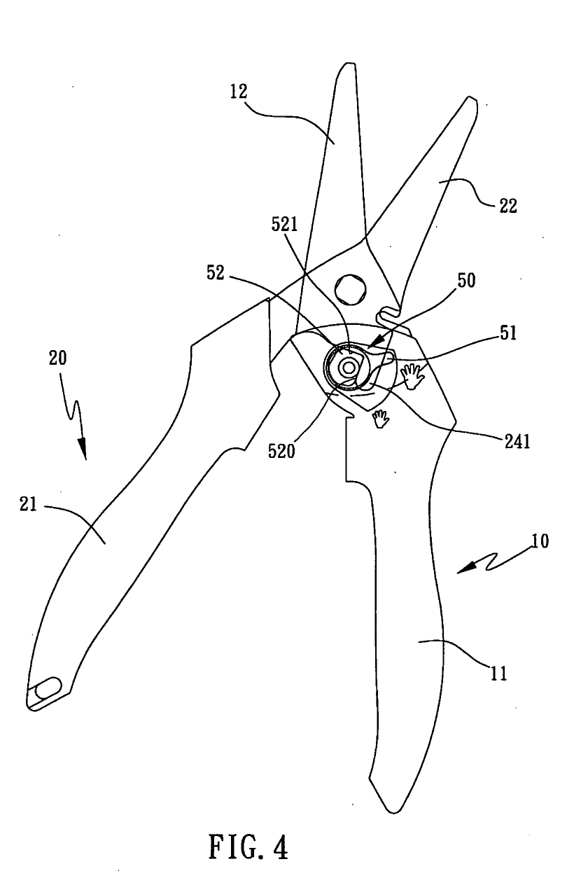

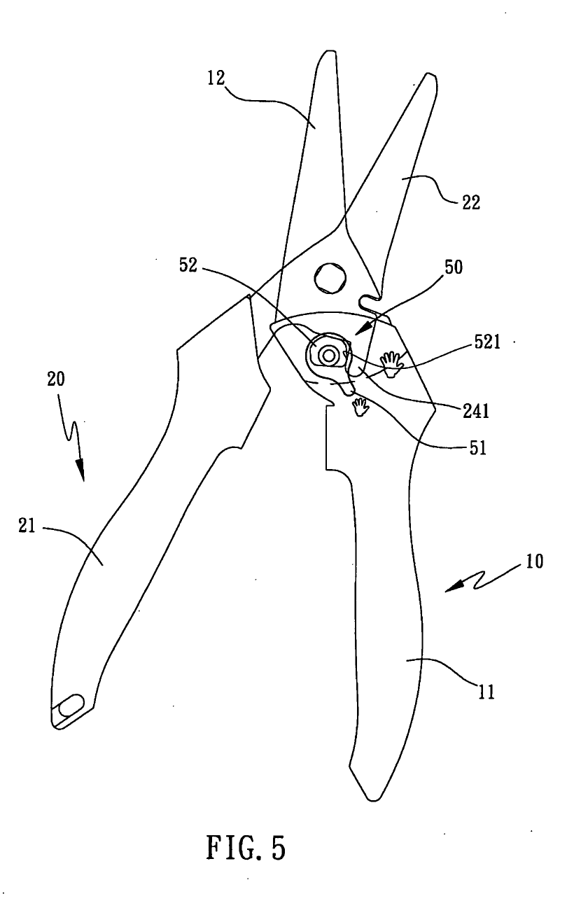

As shown in FIG. 4, when switching the lever 51 to point the index 15 which is a large hand, when releasing the first and second handle 11, 21, the stop 24 is engaged with the first engaging surface 520 which is lower than the second engaging surface 521 so that the width between the first and second blades 12, 22 is wider, which is appropriate for a user with large hands. As shown in FIG. 5, when switching the lever 51 to point the other index 15 which is a small hand, the stop 24 is engaged with the second engaging surface 521 which is higher than the first engaging surface 520 so that the width between the first and second blades 12, 22 is narrower, which is appropriate for a user with small hands. This allows the user not to operate the handles from the widest positions every time pruning flowers. The vertical thicknesses from the axis of the control member 50 to the respective engaging surfaces are different, the stop 24 of the second part 20 is mounted over the control member 50 with the protrusion 241 abutting against the respective engaging surfaces, such arrangements can adjust the open width of the scissors to better fit different user's palm, thus improving the quality and easiness of the pruning operation.

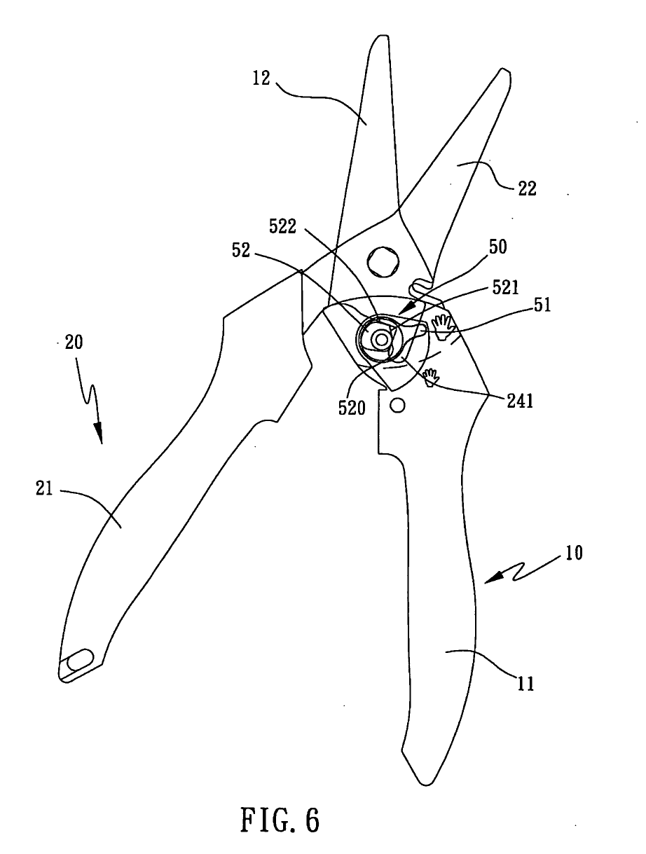

As shown in FIG. 6, the number of the engaging surfaces can be three, such as the first engaging surface 520, the second engaging surface 521 and the third engaging surface 522. The tubular portion 52 of the control member can be provided with a plurality of flat engaging surfaces or can take the form of a cam, to become a multi-step or stepless control device. The vertical thickness from an axis of the control member 50 to the engaging surface 520 is less than that from the axis of the control member 50 to the engaging surface 521, and the vertical thickness from an axis of the control member 50 to the engaging surface 521 is less than that from the axis of the control member 50 to the engaging surface 522.

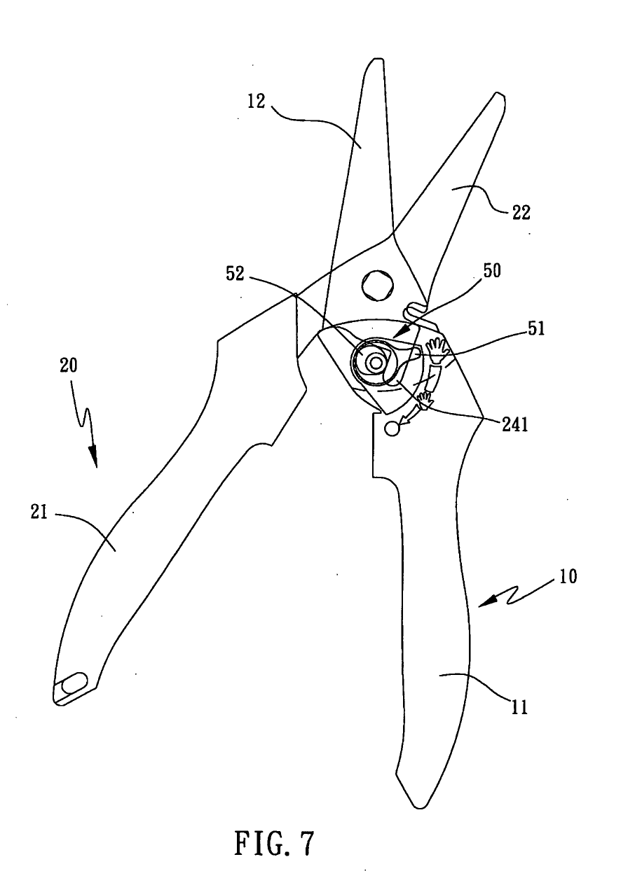

As shown in FIG. 7, the tubular portion 52 of the control member 50 can be a cam which includes continuous spiral surface with different radial heights so that the widths between the first and second blades 12, 22 can be controlled to be any desired widths.

With the aforementioned structures, the following functions and effects can be achieved:

First, simplifying the structure: the control member 50 cooperates with the stop 24 of the second part 20 to form thickness difference, which enables the open width of the scissors to be adjusted better fit different users with different width of palm. It is simplified in structure and naturally reduces the cost.

Second, improving the function: with the cam structure of the tubular portion 52 of the control member 50, the open width of the scissors can be quickly adjusted and controlled.

While we have shown and described the embodiment in accordance with the present invention, it should be clear to those skilled in the art that further embodiments may be made without departing from the scope of the present invention.

What is claimed is:

1. A pair of scissors comprising:
a first part having a first handle and a first blade which is connected to an end of the first handle, a first pivotable hole defined in the first part and located between the first handle and the first blade, the first part having a connection hole;
a second part having a second handle and a second blade which is connected to an end of the second handle, a second pivotable hole defined in the second part and located between the second handle and the second blade, a pin extending through the first and second pivotable holes, the second part having a stop extending from an inside thereof, a spring being connected between the first and second handles; and
a control member rotatably extending through the connection hole and including a plurality of engaging surfaces which have different radial heights so that the stop is engaged with one of the engaging surfaces;
the stop of the second part extending toward the control member to form a protrusion;
wherein vertical thicknesses from an axis of the control member to the respective engaging surfaces are different, the stop of the second part is mounted over the control member with its protrusion abutting against the respective engaging surfaces.

2. The scissors as claimed in claim 1, wherein the control member has a lever extending from a top end thereof and the top end of the control member is located at a top surface of the first part.

3. The scissors as claimed in claim 1, wherein the control member includes a tubular portion which rotatably extends through the connection hole, and on an outer periphery of the tubular portion is defined a plurality of engaging surfaces defined in which have different radial heights and thicknesses.

4. The scissors as claimed in claim 3, wherein the tubular portion of the control member is provided with a plurality of flat engaging surfaces

5. The scissors as claimed in claim 4, wherein the tubular portion of the control member is provided with a first and second engaging surfaces.

6. The scissors as claimed in claim 5, wherein a vertical thickness from an axis of the control member to the engaging surface is less than that from the axis of the control member to the engaging surface.

7. The scissors as claimed in claim 4, wherein the tubular portion of the control member is provided with a first, second and third engaging surfaces.

8. The scissors as claimed in claim 7, wherein a vertical thickness from an axis of the control member to the first engaging surface is less than that from the axis of the control member to the second engaging surface, and a vertical thickness from the axis of the control member to the second engaging surface is less than that from the axis of the control member to the third engaging surface.

9. The scissors as claimed in claim 4, wherein the tubular portion of the control member takes the form a cam.

10. The scissors as claimed in claim 9, wherein the cam of the tubular portion of the control member is a stepless control structure.
